(19) United States
(12) Patent Application Publication
(10) Pub. No.: US 2016/0301098 A1
(43) Pub. Date: Oct. 13, 2016

(54) METHOD OF MAKING POLYMER LITHIUM ION BATTERY

(71) Applicants: Jiangsu Huadong Institute of Li-ion Battery Co. Ltd., Zhangjiagang (CN); Tsinghua University, Beijing (CN)

(72) Inventors: XIANG-MING HE, Beijing (CN); PENG ZHAO, Beijing (CN); JIAN-JUN LI, Beijing (CN); YU-MING SHANG, Beijing (CN); LI WANG, Beijing (CN); JU-PING YANG, Beijing (CN); JIAN GAO, Beijing (CN); YAO-WU WANG, Beijing (CN)

(21) Appl. No.: 15/185,023

(22) Filed: Jun. 17, 2016

Related U.S. Application Data
(63) Continuation of application No. PCT/CN2014/093390, filed on Dec. 9, 2014.

(30) Foreign Application Priority Data
Dec. 24, 2013 (CN) 201310720652.8

(51) Int. Cl. H01M 10/058; H01M 10/0565; C08F 230/08; H01M 10/0525

(52) U.S. Cl. CPC H01M 10/058; H01M 10/0525; H01M 10/0565; C08F 230/08

(57) ABSTRACT

A method of making a polymer lithium ion battery comprises following steps. A case and a battery core located within the case are provided. A mixture is obtained by mixing a first polymer monomer, a second polymer monomer, and a conventional electrolyte solution, wherein the second polymer monomer comprises siloxy group. A lithium ion battery preform is formed by injecting the mixture into the case and sealing the case. The lithium ion battery preform is irradiated with a radiation light, wherein the first polymer monomer and the second polymer monomer are polymerized.

### CROSS-REFERENCE TO RELATED APPLICATIONS

This application claims all benefits accruing under 35 U.S.C. §119 from China Patent Application No. 201310720652.8, filed on Dec. 24, 2013 in the China Intellectual Property Office, the content of which is hereby incorporated by reference. This application is a continuation under 35 U.S.C. §120 of international patent application PCT/CN2014/093390 filed on Dec. 09, 2014.

### FIELD

The present invention relates to a method of making lithium ion battery, and especially to a method of making lithium ion battery based on a gel polymer electrolyte.

At present, with the development of electric vehicles and portable electronic devices, such as mobile phones, digital cameras and notebook computers, the market demand for high power, high energy density of the battery is growing. Lithium-based batteries have the highest voltage in the industrialized battery, the maximum energy density by far, and have good prospects for development.

Electrolyte is an important component of the lithium-based battery. Current lithium-ion batteries adopt liquid electrolyte system. Although lithium-ion battery with the conventional liquid electrolyte has a good high-rate charge/discharge characteristics and low temperature performance, there is leakage and other security risks. At present, the method of preparing the gel polymer electrolyte in the lithium ion battery is generally to prepare a cross-linked polymer film by adding initiator, assemble the cross-linked polymer with positive and negative battery, and then encapsulate the battery after injecting the liquid electrolyte.

In addition, the lithium-ion battery electrolyte often generates hydrofluoric acid during operation. The hydrofluoric acid has great influence to the battery capacity, cycle life and safety. Furthermore, the presence of the initiator will affect the battery capacity and other properties, thus the lithium-ion battery life will be affected.

### BRIEF DESCRIPTION OF THE DRAWINGS

Implementations are described by way of example only with reference to the attached figures.

Specific embodiments are described above in conjunction with the accompanying drawings further illustrate the invention.

FIG. 1 shows a schematic flowchart of one embodiment of a method of making lithium ion battery.

FIG. 2 shows a schematic graph of one embodiment of a ratio between PEGDMA and MMA, and a percentage of PEGDMA and the MMA in the lithium ion battery.

FIG. 3 shows a schematic graph of one embodiment of a graph between charge/discharge capacity-voltage of the polymer lithium ion battery.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprise” or “comprising” when utilized, means “comprise or including, but not necessarily limited to”; it specifically indicates open-ended inclusion or membership in the so-described combination, group, series, and the like. The term “join” or “joining” when utilized, means “directly connect or connected by chemical bond.”

The present invention provides a method of making a polymer lithium ion battery. The method comprises: encapsulating a first polymer monomer and a second polymer monomer in a polymer lithium ion battery; forming a gel polymer electrolyte by polymerizing the first polymer monomer and the second polymer monomer via irradiating the first polymer monomer and the second polymer monomer, wherein the first polymer monomer comprises crosslink groups, and the second polymer monomer comprises siloxy groups.

The method of making polymer lithium ion battery comprises:

providing a case and a battery core disposed within the case;

forming a mixture by mixing the first polymer monomer, the second polymer monomer, and a conventional electrolyte;

forming a lithium ion battery perform by injecting the mixture into the case, and sealing the case;

polymerizing the first polymer monomer and the second polymer monomer by irradiating the lithium ion battery perform with an radiation light.

The battery core comprises a positive electrode, a negative electrode, and a separator. The positive electrode, the separator, and the negative electrode can be sequentially stacked or wound.

The positive electrode can comprise a positive electrode active material and a binder. In one embodiment, the positive electrode further comprises a conductive agent. The positive electrode active material can be selected from LiₓNi_{1-y} CoO₂ (wherein, 0.9≦x≦1.1, 0≦y≦1.0), LiₘMn₂₋ₙBₙO₂ (wherein, B is a transition metal, 0.9<m<1.1, 0≦n≦1.0), Li₁₊ₐM_{b}Mn_{2-b}O₄ (wherein, −0.1≦a<0.2, 0≦b≦1.0, M is lithium, boron, magnesium, aluminum, titanium , chromium, iron, cobalt, nickel, copper, zinc, gallium, yttrium, fluorine, iodine, or sulfur). The conductive agent can be carbon black, acetylene black, conductive graphite, carbon fibers, carbon nanotubes, nickel powder, or copper powder.

The negative electrode comprises a negative active material and a binder. The negative electrode active material can be selected from natural graphite, artificial graphite, petroleum coke, pyrolysis of organic carbon, mesophase carbon microbeads, carbon fiber, tin alloys, silicon alloys, or carbon nanotubes. The binder can be selected from polyvinyl alcohol, polytetrafluoroethylene, carboxymethyl cellulose (CMC), or styrene-butadiene rubber (SBR).

The separator has electrical insulating properties and liquid retention properties. The separator is disposed between the positive electrode and negative electrode, and sealed in the case with the positive electrode, the negative electrode, and the conventional electrolyte. A type of the separator can be modified polyethylene separator, modified polypropylene separator, fine glass fiber separator, vinylon separator, a nylon separator, or a composite film with nylon separator and polyolefin separator welded together.

The material of the case can be metal or non-metallic.

The conventional electrolyte can be a nonaqueous electrolyte. A ratio between a total mass of the first polymer monomer and a mass of the second polymer monomer and the conventional electrolyte solution can range from 1:5 to 1:1. The non-aqueous electrolyte comprises a nonaqueous solvent, and an electrolyte dissolved in the nonaqueous solvent. The nonaqueous solvent can be any known nonaqueous solvent. The nonaqueous solvent can be high-boiling solvent, low-boiling solvent, or a mixture thereof, such as γ-butyrolactone, ethylene carbonate, ethyl methyl carbonate, dimethyl carbonate, diethyl carbonate, ethylmethyl carbonate, methylpropyl carbonate, ethylpropyl carbonate, dimethyl carbonate, dipropyl carbonate, propylene carbonate, ethylene carbonate, vinylene carbonate, diphenyl carbonate, ester, methyl acetate, ethyl acetate, methyl propionate, ethyl propionate, dimethoxyethane, diethoxyethane, sultones, fluorine-containing organic esters, sulfur-containing organic esters, unsaturated bond containing cyclic organic esters, organic acid anhydrides, of N-methylpyrrolidone, of N-methyl-carboxamide, N-dimethylacetamide, acetonitrile, N, N-dimethylformamide, sulfolane, or dimethyl sulfoxide.

The electrolyte dissolved in the nonaqueous solvent can be generally used for nonaqueous secondary lithium battery electrolyte, such as lithium hexafluorophosphate (LiPF₆), lithium tetrafluoroborate (LiBF₄), lithium hexafluoroarsenate (LiSbF₆), lithium perchlorate (LiClO₄), lithium perfluoroalkyl sulfonate (LiCF₃SO₃), Li (CF₃SO₂)₂N, LiC₄F₉SO₃, chloro-aluminum lithium (LiAlCl₄), LiN(CₓF₂ₓ₊₁SO₂) (C_{y}F_{2y-1}SO₂) (where x and y are natural numbers of 1 to 10), lithium chloride (LiC1), or iodine lithium (LiI). A concentration of the electrolyte in the nonaqueous electrolyte can range from 0.1 mol/l to 2.0 mol/1. In one embodiment, the concentration ranges from 0.7 mol/l to 1.6 mol/l. A usage of the nonaqueous electrolyte can range from 3 mg/mAh to 6 mg/mAh.

The first polymer monomer comprises a crosslink group. Furthermore, the first polymer monomer can also be a mixture of a first sub-polymer monomer with two or more kinds of functional groups and a second sub-polymer monomer with one kind of functional group. The first sub-polymer monomer with two or more kinds of functional groups can be selected from a group consisting of polyethylene glycol dimethacrylate (PEGDMA), three ethoxy methacrylate, glycidyl acrylate, glycidyl trimethyl, ethyl ethoxylated bisphenol A dimethacrylate, and divinylbenzene. The second sub-polymer monomer with one kind of functional group can be selected from methyl methacrylate

(MMA), ethyl methacrylate, butyl methacrylate, methyl acrylate, butyl acrylate, ethylene glycol methyl ether acrylate, ethyl glycol methyl methacrylate, or acrylonitrile. While the first polymer monomer is the mixture, a ratio between the first sub-polymer monomer and the second sub-polymer monomer is greater than or equal to 1:4. The higher the ratio of first sub-polymer monomer, the more likely to form a gel.

The second polymer monomer comprises silicon groups, such as alkyl siloxy group. The alkyl siloxy group has a general formula:

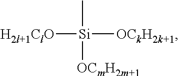

wherein, k≧1, l≧1, m≧1. The k, l, m can be equal or unequal. Furthermore, the general formula of the siloxy group can be expressed as Si(OCₙH₂ₙ₊₁)₃, n≧1. Furthermore, the n satisfies 1≦n≦3, in order to reduce the production cost of the lithium ion battery and suitable for industrial production. The second polymer monomer can be γ-methacryloxy propyl triethoxysilane (TEPM), γ-methacryloxypropyl trimethoxy silane (TMPM), or combination thereof. Furthermore, the second polymer monomer comprises crosslink group in order to be polymerized with the first polymer monomer. The crosslink group in the second polymer monomer can be conventional crosslink group.

After the mixture is injected into the case, the case will be closed to form a closed structure. The method of closing the case can be selected according to the material of the case.

The radiation light can be X-rays, γ rays, or β rays. The radiation light can penetrate the case, incident on the mixture, and initiate the polymerization of the first polymer monomer and the second polymer monomer. The irradiation dose and the irradiation time can be selected according to the capacity of the mixture, ensuring that the first polymer monomer and the second polymer monomer can be polymerized sufficiently. The radiation dose can range from 5kGy to 10kGy, the radiation dose rate can be 100-300Gy/min. After the irradiation of the radiation light, the polymerization will be introduced between the first polymer monomers themselves, the second polymer monomers themselves, and the first polymer monomer and the second polymer monomer.

The embodiments will be illustrated according to following drawings.

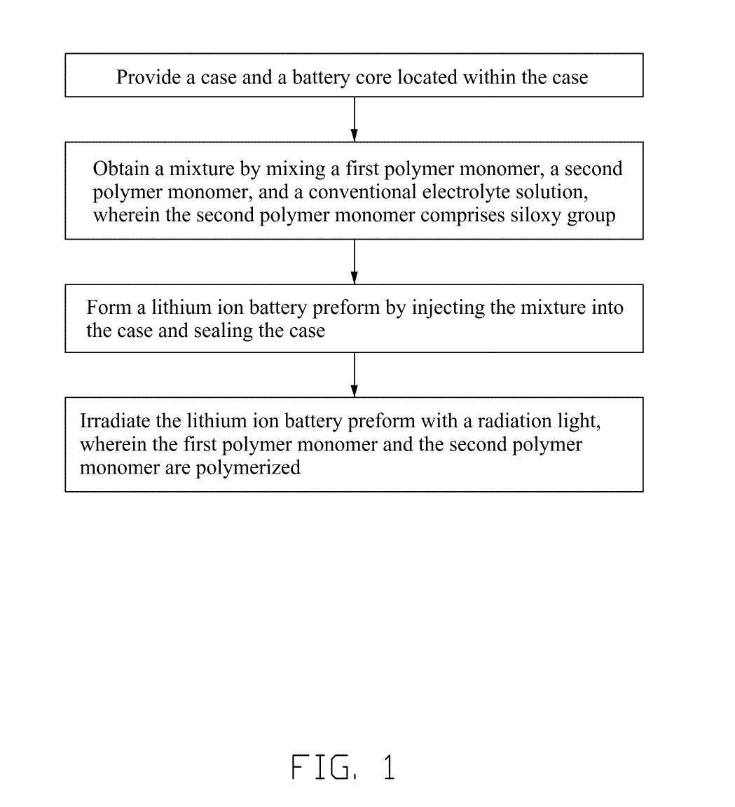

Referring to FIG. 1, one embodiment of a method of making polymer lithium ion battery comprising:

Step S10, providing a case and a battery core located within the case;

Step S20, obtaining a mixture by mixing a first polymer monomer, a second polymer monomer, and a conventional electrolyte solution;

Step S30, forming a lithium ion battery preform by injecting the mixture into the case and sealing the case; and

Step S40, irradiating the lithium ion battery preform with a radiation light, wherein the first polymer monomer and the second polymer monomer are polymerized.

In step S10, the positive electrode, the separator, and negative electrode are stacked and wound to form the battery core, and then incorporated into an aluminum case of 4.2 mm×30 mm×48 mm.

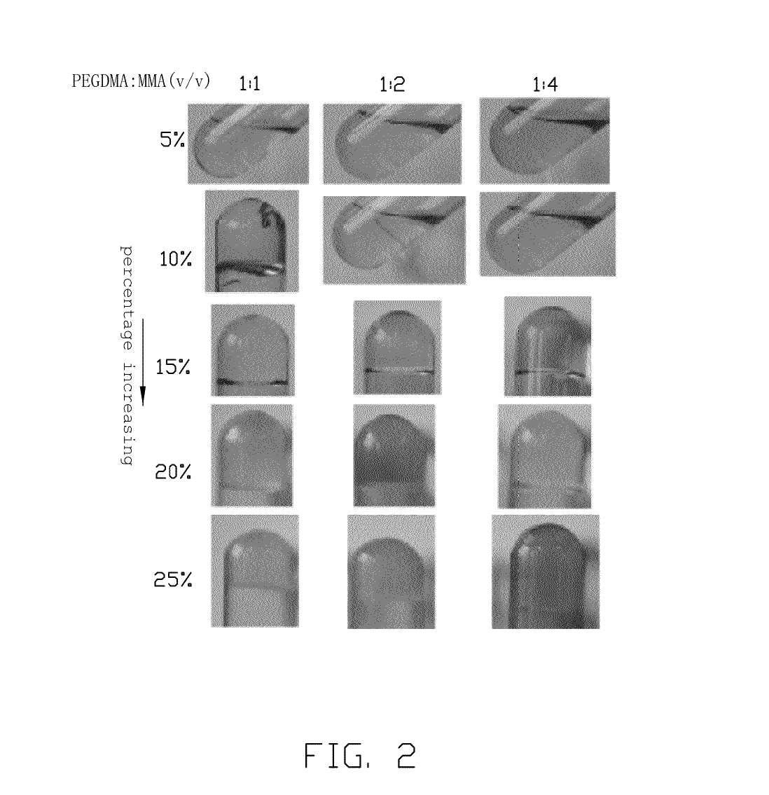

In step S20, further referring to FIG. 2, the first polymer monomer comprises ethylene glycol dimethacrylate (PEGDMA) and methyl methacrylate (MMA). The mass ratio between PEGDMA and MMA satisfy: PEGDMA:MMA≧1:4. In this embodiment, the mass ratio between PEGDMA and MMA satisfy: PEGDMA:MMA=1:1. The conventional electrolyte solution is lithium hexafluorophosphate (LiPF 6)-ethylene carbonate (EC)-ethyl methyl carbonate (EMC)-dimethyl carbonate (DMC). The higher the content of ethylene glycol dimethacrylate (PEGDMA), the more likely to form a gel. While the PEGDMA:MMA=1:1, the volume of PEGDMA and MMA in the electrolyte solution is 10%, then the gel can be formed.

The second polymer monomer comprises y-methacryloxy propyl triethoxysilane (TEPM) and γ-methacryloxypropyl trimethoxy silane (TMPM). The mass ratio between the second polymer monomer and the first polymer monomer satisfy: PEGDMA:(MMA+TMPM+TEPM)≧1:4. In detail, in the second polymer monomer, the mass ratio between the TEPM and TMPM can be adjusted according to the desired reaction rate with the hydrofluoric acid. In this embodiment, the mass ratio between TEPM and TMPM is 1:1.

In step S40, the radiation light is γ-rays generated by Co60. The irradiation dose is about 5kGy, and the irradiation dose rate is about 100 Gy/min. Under the irradiation of the y-rays, the mixture generates following reaction:

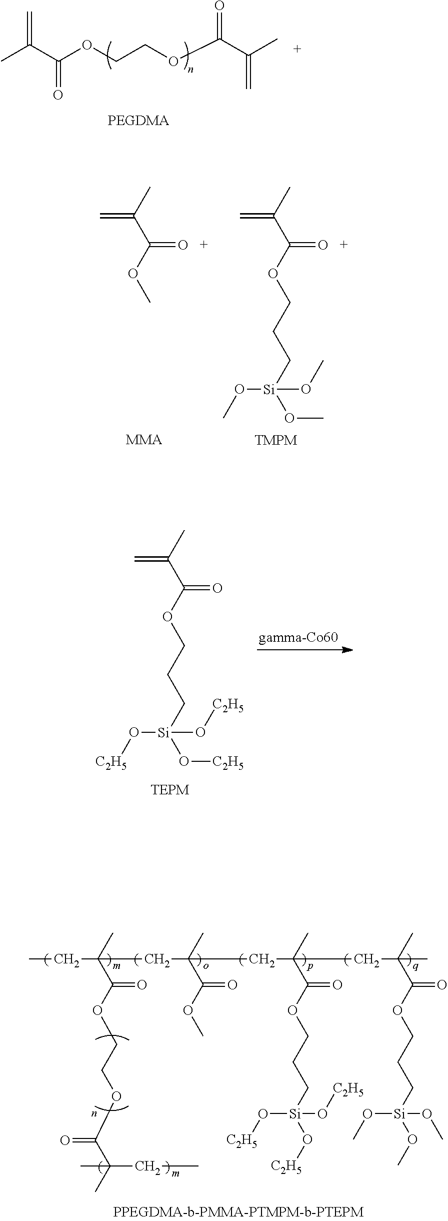

wherein, 1≦n≦113, 0≦m, o<100, p≦100, q≦100.

In the irradiation process, the ethylene glycol dimethacrylate (PEGDMA) is polymerized to form polyethylene glycol dimethacrylate (PPEGDMA). The methyl methacrylate (MMA) is polymerized to form the polymethyl methacrylate (PMMA). Furthermore, the polyethylene glycol dimethacrylate (PPEGDMA) and the polymethyl methacrylate (PMMA) is polymerized to form an interpenetrating polymer network (IPN). The interpenetrating polymer network is configured as a “skeleton” of the polymer electrolyte. The γ-methacryloxy propyl triethoxysilane (TEPM) is polymerized to form poly-acryloxy propyl triethoxysilane (PTEPM), and the connected to the skeleton. Similarly, the γ-methacryloxypropyl trimethoxy silane (TMPM) is polymerized to form poly-methacryloxy propyl trimethoxy silane (PTMPM), and connected to the skeleton to form the gel polymer electrolyte.

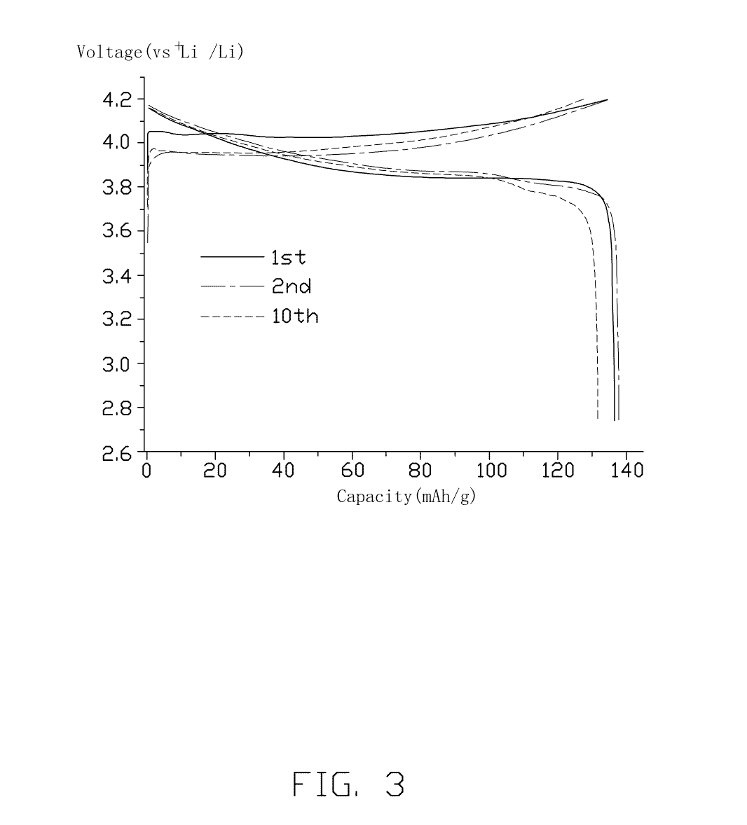

Referring to FIG. 3, the initial discharge capacity of the polymer lithium ion battery in this embodiment reaches 137mAh/g. After repeating charging and discharging, the capacity of the lithium-ion polymer battery is substantially maintained. Thus the polymer lithium-ion battery has excellent performance and long lifespan.

The polymer lithium ion battery has following advantages. The polymer monomers are sealed in the case and initiated the reaction via irradiation, thus the additional initiator can be avoided. The performance of polymer lithium-ion battery can be improved. Furthermore, the siloxy group is introduced into the polymer electrolyte, thus the hydrofluoric acid generated during the battery cycle can be fully absorbed. The production generated during the reaction of the silicon oxy group and the hydrofluoric acid is connected to the polymer skeleton, and will not diffused to the electrode surface. Thus the cycle life and safety of the polymer lithium-ion battery can be improved. Therefore, the gel polymer electrolyte has good thermal and electrochemical stability, and the polymer lithium based battery based on the gel polymer electrolyte has relatively large power, higher stability, and great security.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a lithium ion battery, the method comprising:
providing a case with a battery core located within the case;
obtaining a mixture by mixing a first polymer monomer, a second polymer monomer, and a conventional electrolyte solution, wherein the second polymer monomer comprises a siloxy group;
forming a lithium ion battery preform by injecting the mixture into the case and sealing the case; and
irradiating the lithium ion battery preform with a radiation light, wherein the first polymer monomer and the second polymer monomer are polymerized.

2. The method of claim 1, wherein the siloxy group is an alkyl siloxy group.

3. The method of claim 2, wherein the alkyl siloxy group has a general formula: 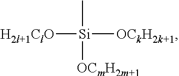
wherein, k≧1, l≧1, m≧1.

4. The method of claim 2, wherein the alkyl siloxy group has a general formula Si(OCₙH₂ₙ₊₁)₃, n≧1.

5. The method of claim 1, wherein the second polymer monomer comprises γ-methacryloxy propyl triethoxysilane (TEPM) or γ-methacryloxypropyl trimethoxy silane (TMPM).

6. The method of claim 1, wherein the radiation light is selected from the group consisting of X ray, γ ray, and β ray.

7. The method of claim 6, wherein the radiation light is y ray, a radiation dose of the radiation light ranges from 5kGy to 10kGy, and a radiation dose rate of the radiation light ranges from 100 Gy/min to 300 Gy/min.

8. The method of claim 1, wherein a ratio between a total mass of the first polymer monomer and the second polymer monomer and a mass of the conventional solution ranges from 1:5 to 1:1.

9. The method of claim 1, wherein the first polymer monomer comprises a crosslink group.

10. The method of claim 9, wherein the first polymer monomer comprises a first sub-polymer monomer and a second sub-polymer monomer, the first sub-polymer monomer comprises more than two kinds of functional groups, and the second sub-polymer monomer comprises one kind of functional group.

11. The method of claim 10, wherein the first sub-polymer monomer is selected from the group consisting of polyethylene glycol dimethacrylate (PEGDMA), three ethoxy methacrylate, glycidyl acrylate, glycidyl trimethyl, ethyl ethoxylated bisphenol A dimethacrylate, and divinylbenzene.

12. The method of claim 10, wherein a ratio between the first sub-polymer monomer and the second sub-polymer monomer is greater than or equal to 1:4.

13. The method of claim 1, wherein the first polymer monomer comprises ethylene glycol dimethacrylate (PEGDMA) and methyl methacrylate (MMA), the second polymer monomer comprises γ-methacryloxy propyl triethoxysilane (TEPM) or γ-methacryloxypropyl trimethoxy silane (TMPM), and a mass ratio among the PEGDMA, MMA, TEMP, and TMPM satisfies: PEGDMA:(MMA+TMPM+TEPM)≧1:4.

14. The method of claim 13, wherein the mixture generates following reaction: 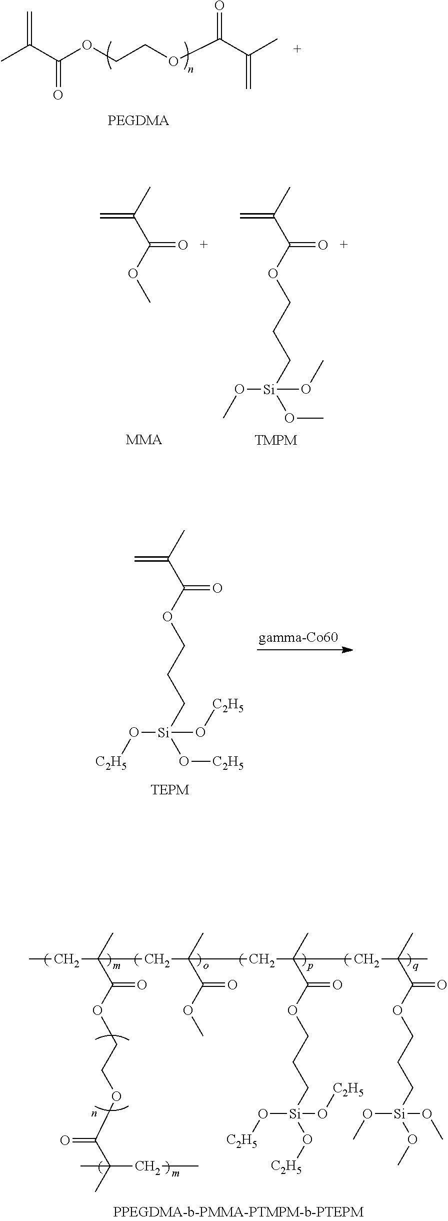
wherein, 1≦n≦113, 0≦m, o≦100, p≦100, q≦100.
